(19) United States
(12) Patent Application Publication
(10) Pub. No.: US 2021/0387576 A1
(43) Pub. Date: Dec. 16, 2021

(54) Seatback Phone Mount Apparatus

(71) Applicant: Theresa Soon, Katy, TX (US)

(72) Inventor: Theresa Soon, Katy, TX (US)

(21) Appl. No.: 16/898,536

(22) Filed: Jun. 11, 2020

(51) Int. Cl. B60R 11/02

(52) U.S. Cl. CPC B60R 11/0241; B60R 2011/0015

(57) ABSTRACT

A seatback phone mount apparatus for securing a phone to a seatback includes a main base. A pair of expandable supports is coupled to a base left side and a base right side of the main base. Each expandable support slidably moves between a compressed position and an extended position. A pair of seat clips is coupled to the pair of expandable supports. Each seat clip is coupled to a distal end of each expandable support. The pair of seat clips selectively engages a pair of seat sides of a seatback. A neck is coupled to a base front side of the main base. A phone plate is coupled to the neck. A magnet is coupled within the phone plate to secure a cellphone to the phone plate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to phone mounting devices and more particularly pertains to a new phone mounting device for securing a phone to a seatback.

### (2) Description of Related Art Including Information Disclosed Under 37 CFR 1.97 and 1.98

The prior art relates to phone mounting devices. Existing devices specifically designed for a seatback often employ straps that must wrap around the seat and may disturb the person occupying said seat, particularly on a plane or public transit. Other phone mounting devices only work on flat, solid surfaces such as walls and tables.

### BRIEF SUMMARY OF THE INVENTION

An embodiment of the disclosure meets the needs presented above by generally comprising a main base having a base front side, a base back side, a base left side, a base right side, a base top side, and a base bottom side. A pair of expandable supports is coupled to the base left side and the base right side of the main base. Each expandable support slidably moves between a compressed position and an extended position. A pair of seat clips is coupled to the pair of expandable supports. Each seat clip is coupled to a distal end of each expandable support. The pair of seat clips is configured to selectively engage a pair of seat sides of a seatback. A neck is coupled to the base front side of the main base. A phone plate is coupled to the neck. A magnet is coupled within the phone plate and is configured to secure a cellphone to the phone plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a seatback phone mount apparatus according to an embodiment of the disclosure.

FIG. 2 is a top plan view of an embodiment of the disclosure.

FIG. 3 is a front elevation view of an embodiment of the disclosure.

FIG. 4 is a rear elevation view of an embodiment of the disclosure.

FIG. 5 is a side elevation view of an embodiment of the disclosure.

FIG. 6 is an in-use view of an embodiment of the disclosure.

### DETAILED DESCRIPTION OF THE INVENTION

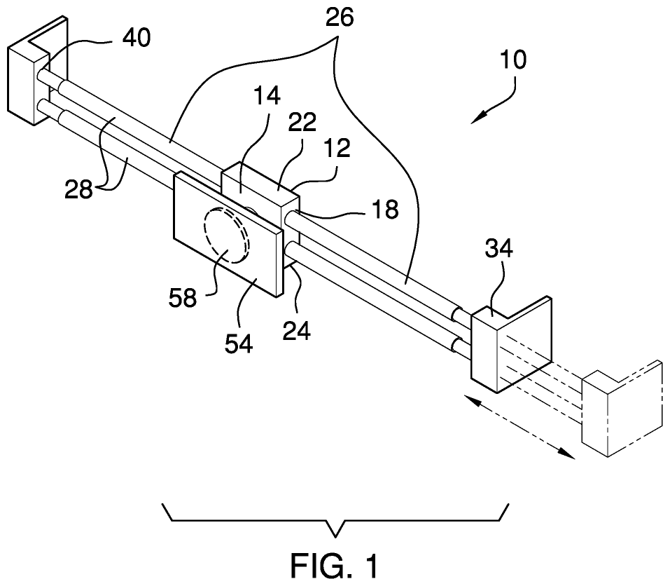

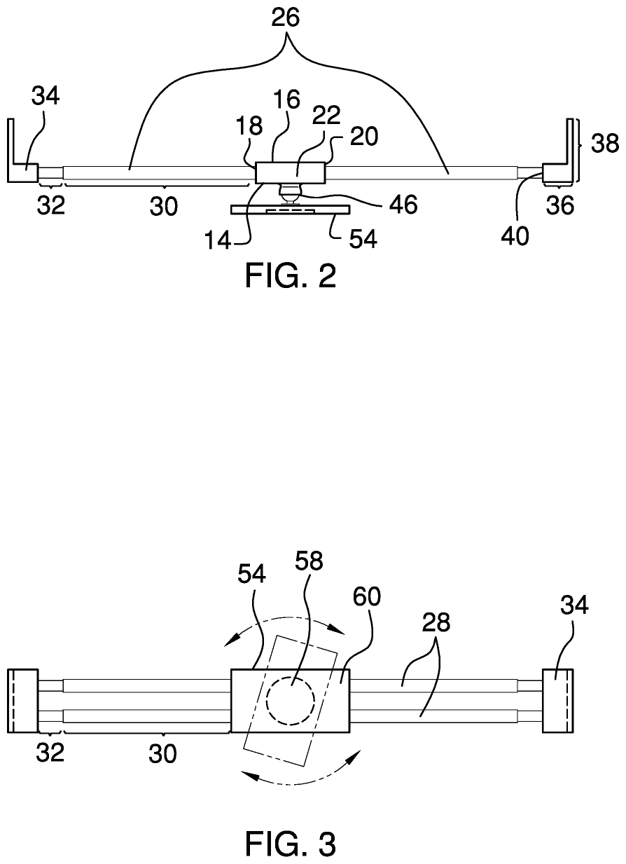

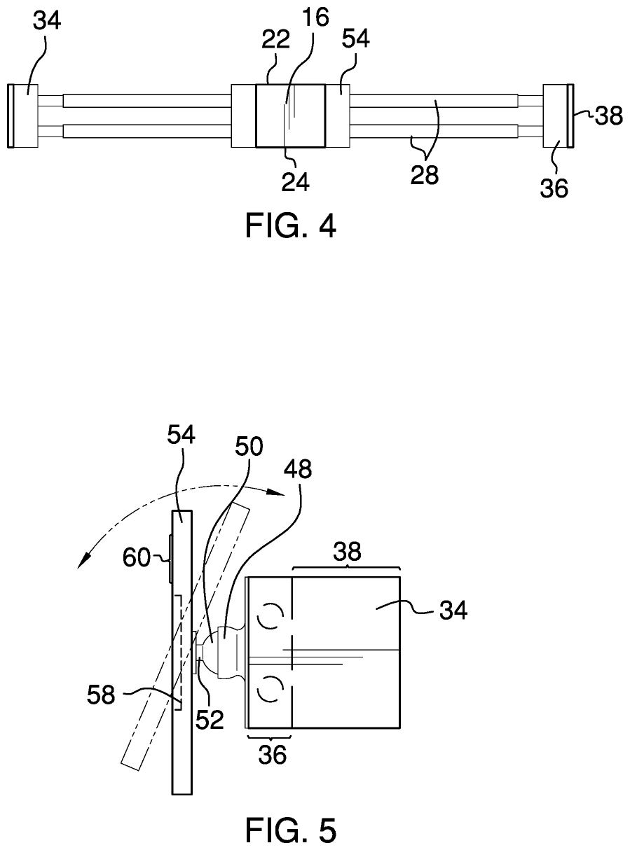

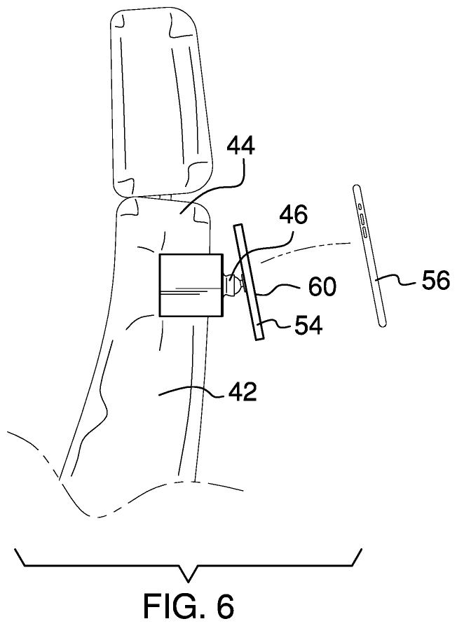

With reference now to the drawings, and in particular to FIGS. 1 through 6 thereof, a new phone mounting device embodying the principles and concepts of an embodiment of the disclosure and generally designated by the reference numeral 10 will be described.

As best illustrated in FIGS. 1 through 6, the seatback phone mount apparatus 10 generally comprises a main base 12 having a base front side 14, a base back side 16, a base left side 18, a base right side 20, a base top side 22, and a base bottom side 24. A pair of expandable supports 26 is coupled to the base left side 18 and the base right side 20 of the main base. Each expandable support 26 slidably moves between a compressed position and an extended position.

Each expandable support 26 may comprise a pair of telescoping arms 28 with each telescoping arm 28 having a fixed portion 30 coupled to either the base left side 18 or the base right side 20 and a sliding portion 32 coupled within the fixed portion 30. The pair of telescoping arms 28 is arranged horizontally in the same vertical plane. Each expandable support 26 may be spring-loaded and biased towards the compressed position or may alternatively maintain its position until moved by a user.

A pair of seat clips 34 is coupled to the pair of expandable supports 26. Each seat clip 34 may be L-shaped with a thick portion 36 coupled to the respective expandable support 26 and a thin perpendicular portion 38 extending from the thick portion 36. The thick portion 36 of each seat clip is coupled to a distal end 40 of each expandable support 26. The pair of seat clips 34 is configured to selectively engage a pair of seat sides 42 of a seatback 44.

A neck 46 is coupled to the base front side 14 of the main base. The neck 46 may be pivotable and rotatable and maintains its position until moved by the user. The neck 46 may include a socket 48 attached to the base front side 14, a ball 50 coupled within the socket 48, and an extension 52 coupled to the ball 50. The ball 50 must have sufficient friction within the socket 48 to maintain its position until moved by the user. The neck 46 may alternatively be another pivotable and rotatable extension such as, but not limited to, a multiple pivot cantilever, gooseneck tubing, or the like.

A phone plate 54 is coupled to the neck 46. The phone plate 43 may be coupled to the extension 52. The phone plate 54 is dimensioned to approximate the size of either a smartphone 56 or a tablet. A magnet 58 is coupled within the phone plate 54 and is configured to secure the smartphone 56 to the phone plate 54. The phone plate 54 may alternatively have a selectively engageable fastener coupled to a plate front side 60 of the phone plate to selectively engage another selectively engageable fastener coupled to the smartphone 56 or tablet.

In use, the pair of expandable supports 26 is moved to the extended position and placed adjacent the seatback 44, and then moved towards the compressed position until the pair of seat clips 34 engage the pair of seat sides 44. The smartphone 56 or tablet is then engaged with the phone plate 54 and the neck 46 is manipulated until the desired orientation is achieved.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seatback phone mount apparatus comprising:
a main base having a base front side, a base back side, a base left side, a base right side, a base top side, and a base bottom side;
a pair of expandable supports coupled to the main base, the pair of expandable supports being coupled to the base left side and the base right side, each expandable support slidably moving between a compressed position and an extended position, each expandable support being spring-loaded and biased to move towards each other into the compressed position;
a pair of seat clips coupled to the pair of expandable supports, each seat clip being coupled to a distal end of each expandable support, the pair of seat clips being configured to selectively engage a pair of seat sides of a seatback, each seat clip being L-shaped;
a neck coupled to the main base, the neck being coupled to the base front side;
a phone plate coupled to the neck; and
a magnet coupled within the phone plate, the magnet being configured to secure a cellphone to the phone plate.

2. The seatback phone mount apparatus of claim 1 further comprising each expandable support comprising a pair of telescoping arms.

3. The seatback phone mount apparatus of claim 1 further comprising each telescoping arm having a fixed portion coupled to either the base left side or the base right side and a sliding portion coupled within the fixed portion.

4. (canceled)

5. The seatback phone mount apparatus of claim 1 further comprising the neck being pivotable and rotatable.

6. The seatback phone mount apparatus of claim 1 further comprising the neck including a socket attached to the base front side, a ball coupled within the socket, and an extension coupled to the ball, the phone plate being coupled to the extension.

7. The seatback phone mount apparatus of claim 1 further comprising each seat clip being L-shaped.

8. The seatback phone mount apparatus of claim 1 further comprising each seat clip having a thick portion coupled to the respective expandable support and a thin perpendicular portion extending from the thick portion.

9. A seatback phone mount apparatus comprising:
a main base having a base front side, a base back side, a base left side, a base right side, a base top side, and a base bottom side;
a pair of expandable supports coupled to the main base, the pair of expandable supports being coupled to the base left side and the base right side, each expandable support slidably moving between a compressed position and an extended position, each expandable support comprising a pair of telescoping arms, each telescoping arm having a fixed portion coupled to either the base left side or the base right side and a sliding portion coupled within the fixed portion, each expandable support being spring-loaded and biased to move towards each other into the compressed position;
a pair of seat clips coupled to the pair of expandable supports, each seat clip being L-shaped and having a thick portion coupled to the respective expandable support and a thin perpendicular portion extending from the thick portion, the thick portion of each seat clip being coupled to a distal end of each expandable support, the pair of seat clips being configured to selectively engage a pair of seat sides of a seatback;
a neck coupled to the main base, the neck being coupled to the base front side, the neck being pivotable and rotatable, the neck including a socket attached to the base front side, a ball coupled within the socket, and an extension coupled to the ball;
a phone plate coupled to the neck, the phone plate being coupled to the extension; and
a magnet coupled within the phone plate, the magnet being configured to secure a cellphone to the phone plate.
